(19) United States
(12) Patent Application Publication
(10) Pub. No.: US 2008/0137897 A1
(43) Pub. Date: Jun. 12, 2008

(54) WIRELESS EARPHONE RETAINED BY HELIX OF EAR

(76) Inventor: Serina Liu, Baldwin, CA (US)

Correspondence Address: LEONG C LEI, PMB # 1008, 1867 YGNACIO VALLEY ROAD, WALNUT CREEK, CA, 94598, US

(21) Appl. No.: 11/567,227

(22) Filed: Dec. 6, 2006

(51) Int. Cl. H04R 25/00

(52) U.S. Cl. 381/380

(57) ABSTRACT

A wireless earphone is retained in a user's ear by engaging a helix and includes a body from which an earphone plug extends and a speaker bar extending from the body. A spherical connection if formed between the body and the plug and is clamped by a resilient fork formed at a first end of a support rod. The support rod has a second end forming a helix engaging portion that is engageable with the helix. The support rod is rotatable about a center of the spherical connection to change distance and angle between the helix, engaging portion and the earphone plug, whereby when a user puts the helix engaging portion against the helix and move the body to fit the earphone plug into an auditory canal of the ear, the wireless earphone is stably retained on the ear.

### BACKGROUND OF THE INVENTION

(a) Technical Field of the Invention

The present invention relates to a wireless earphone, and in particular to a wireless earphone that is stably and comfortably retained in a user's ear by employing spherical coupling for adjustment of distance and angle and resiliency-based engagement and retention so as to alleviate the drawback of hurting ear by component straddling over the ear

(b) Description of the Prior Art

The prevailing of mobile phones provides motivation for development and sales of Bluetooth based wireless earphones to allow a mobile phone user to receive and make phone call in a remote manner without hand holding the mobile phone. The conventional wireless earphone comprises a hook by a body of the earphone and the earphone is put on a user's ear by having the hook engaging and straddling over the user's ear. The hook is often enclosed with a soft cover to ensure excellent skin attachment and comfort of the user. Although the wireless earphone has a very light weight, yet a quite torque is often applied to the ear due to a long arm of force, which when timed by the weight of the earphone, results in a large torque. This hurts the user's ear after a long term use. In addition, abrasion caused by friction between the hook and the ear may further damage the ear. Consequently, it is generally not possible for a user to wear the conventional earphone for a long time.

Thus, it is desired to provide a wireless earphone that allows for comfortable retention in a user's ear so as to overcome the above drawbacks of the conventional earphone.

### SUMMARY OF THE INVENTION

The primary purpose of the present invention is to provide a wireless earphone adapted to be retained in a user's ear by engaging a helix, comprising a body from which an earphone plug extends and a speaker bar extending from the body, wherein a spherical connection is formed between the body and the earphone plug, the spherical connection forming a neck joint with the body, which is clamped by a resilient fork formed at a first end of a support rod, the support rod having an opposite second end forming a helix engaging portion that is engageable with the helix and that is remote from the speaker bar, the support rod being rotatable about a center of the spherical connection to change distance and angle between the helix engaging portion and the earphone plug, whereby when a user puts the helix engaging portion against the helix and move the body to fit the earphone plug into an auditory canal of the ear, the wireless earphone is stably retained on the ear.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

The present invention will be apparent to those skilled in the art by reading the following description of a preferred embodiment thereof, with reference to the attache drawings, wherein:

FIG. 1 is a perspective view of a wireless earphone constructed in accordance with the present invention;

FIG. 2 is also a perspective view of the wireless earphone of the present invention;

FIG. 3 is an exploded view of the wireless earphone constructed in accordance with the present invention;

FIG. 4 demonstrates adjustment of the wireless earphone of the present invention; and

FIG. 5 is a perspective view showing the wireless earphone of the present invention mounted to an ear of a user.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

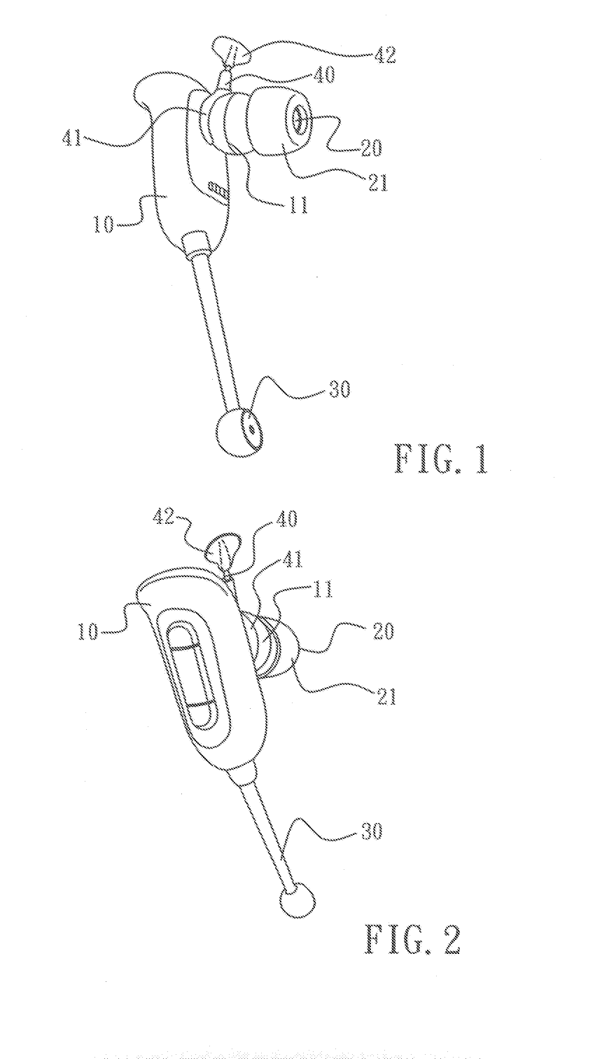

With reference to the drawings and in particular to FIGS. 1 and 2, which show different perspective views of a wireless earphone constructed in accordance with the present invention and retainable by abutting against a helix of ear of a user, the wireless earphone of the present invention comprises a body 10 from which an earphone plug 20 extends sideways. A speaker bar 30 also extends from the body 10. A spherical connection 11 is formed between the body 10 and the earphone plug 20. A neck joint portion between the spherical connection 11 and the body 10 is clamped by resilient fork 41 formed at an end of a support rod 40. An opposite end of the support rod 40 forms a helix engaging portion 42 that is engageable with and retained by an inner folding of a helix of a user and that is remote from the speaker bar 30 of the body 10.

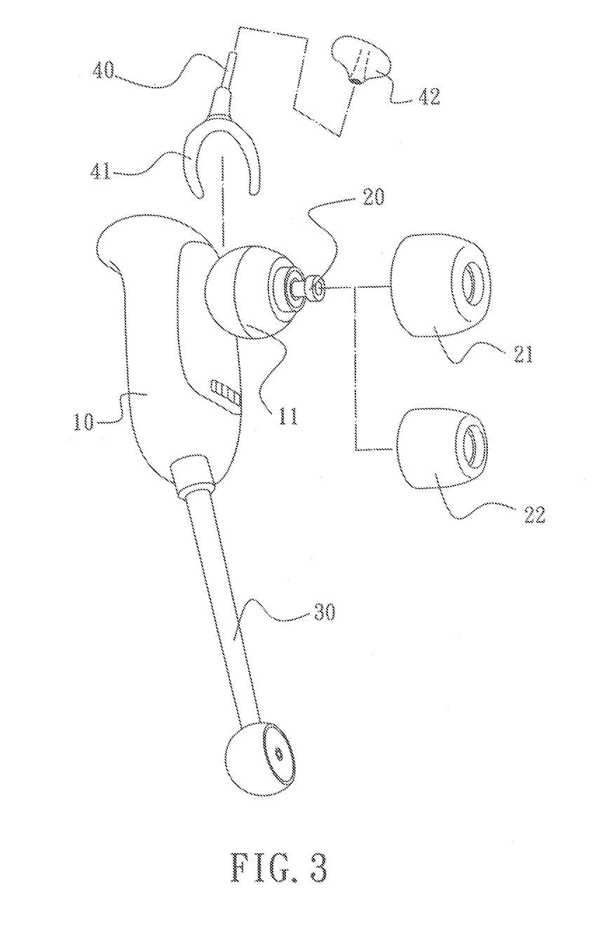

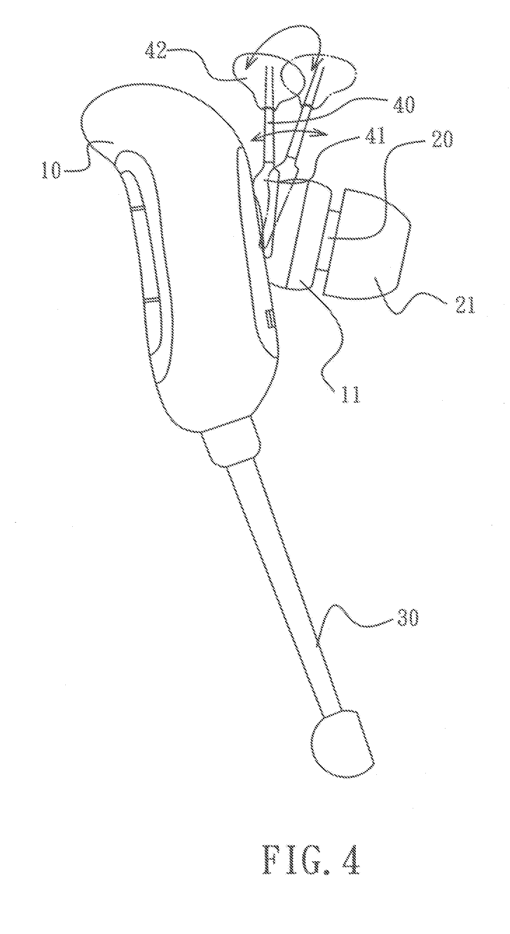

Also referring to FIG. 3, the earphone plug 20 is enclosed by a soft cap 21. The cap 21 is exchangeable with a different-sized cap 22 for users' ears of different sizes. The support rod 40 can be removed from the spherical connection 11 with the resiliency and thus elastic deformation of the form 41. The helix engaging portion 42 is made of a resilient material featuring excellent skin-attachment, such as silicone rubber. The helix engaging portion 42 can be mounted to the support rod 40 by directly inserting said opposite end of the support rod 40 into the helix engaging portion 42. This can be done by for example fitting said end of the support rod 40 into a hold defined in the helix engaging portion 42. As demonstrated in FIG. 4, a user can move the support rod 40 by rotating the support rod 40 about a rotation center defined by a center of the spherical connection 11, which causes the fork 41 to slide along an outer surface of the spherical connection 41. Thus, the distance and angle between the helix engaging portion 42 and the earphone plug 20 are changed accordingly. When the support rod 40 is released, the resiliency of the fork 41 springs the fork 41 back to the neck joint portion between the spherical connection 11 and the body 10. (Similarly, the support rod 40 can be fixed, while the body 10 is rotated with respect to the support rod 40 with the center of the spherical connection 11 as a rotation center. This provides the same adjustment in relative position and relative angular position.) The helix engaging portion 42 can be adjusted individually by rotating about said opposite end of the support rod 40.

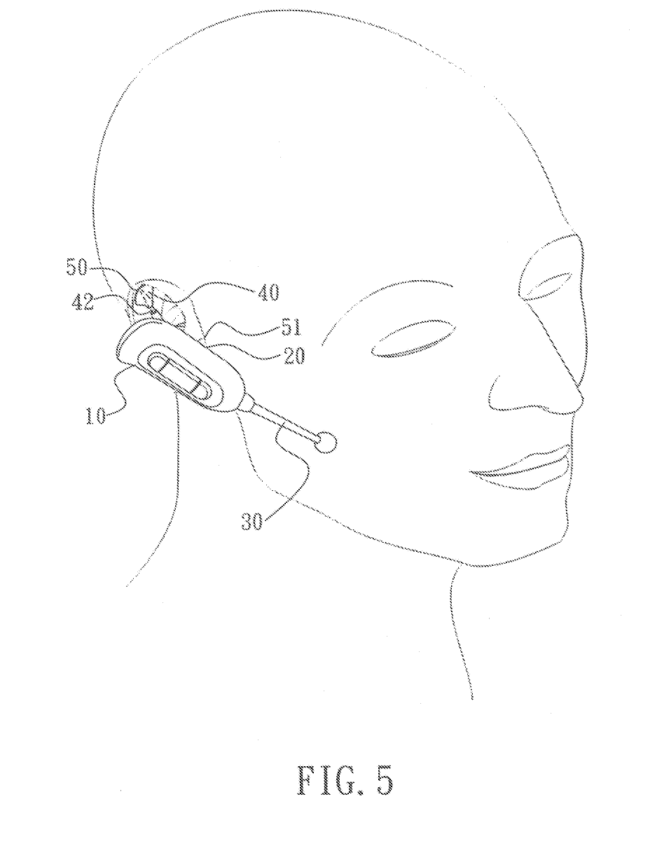

Also referring to FIG. 5, which demonstrates the use of the wireless earphone in accordance with the present invention, the user puts the helix engaging portion 42 of the support rod against the inner fold of a helix 50 and moves the body 10 to allow the earphone plug 20 to insert into an auditory canal 51 of the ear, whereby the earphone is stably retained on the ear by the engagement of the helix engaging portion 42 and the plug 20 with the helix 50 and the canal 51 and comfortable wearing of the earphone is thus realized.

Although the present invention has been described with reference to the preferred embodiment thereof, it is apparent to those skilled in the art that a variety of modifications and changes may be made without departing from the scope of the present invention which is intended to be defined by the appended claims.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A wireless earphone adapted to be retained in a user's ear by engaging a helix, comprising a body from which an earphone plug extends and a speaker bar extending from the body, wherein a spherical connection is formed between the body and the earphone plug, the spherical connection forming a neck joint with the body, which is clamped by a resilient fork formed at a first end of a support rod, the support rod having an opposite second end forming a helix engaging portion that is engageable with the helix and that is remote from the speaker bar, the support rod being rotatable about a center of the spherical connection to change distance and angle between the helix engaging portion and the earphone plug, whereby when a user puts the helix engaging portion against the helix and move the body to fit the earphone plug into an auditory canal of the ear, the wireless earphone is stably retained on the ear.

2. The wireless earphone as claimed in claim 1, wherein the earphone is covered with a soft cap.

3. The wireless earphone as claimed in claim 1, wherein the helix engaging portion comprises a resilient material having excellent skin attachment and wherein the helix engaging portion is mounted to the support rod by directly inserting the second end of the support rod into the helix engaging portion.

4. The wireless earphone as claimed in claim 2, wherein the helix engaging portion comprises a resilient material having excellent skin attachment and wherein the helix engaging portion is mounted to the support rod by directly inserting the second end of the support rod into the helix engaging portion.
